(19) United States
(12) Patent Application Publication
(10) Pub. No.: US 2008/0294467 A1
(43) Pub. Date: Nov. 27, 2008

(54) EDUCATION INSURANCE AND PROCESS OF IMPLEMENTING THE SAME

(76) Inventor: Erich C. Grundy, Grosse Point Woods, MI (US)

Correspondence Address: YOUNG & BASILE, P.C., 3001 WEST BIG BEAVER ROAD, SUITE 624, TROY, MI, 48084, US

(21) Appl. No.: 11/753,666

(22) Filed: May 25, 2007

(51) Int. Cl. G06Q 40/00

(52) U.S. Cl. 705/4

(57) ABSTRACT

An education insurance product and process of implementing the same includes determination of an insurance premium and payment of the insurance premium for an educational insured event where the insured event can be retaken by the insured in the future. At the completion of the event, a determination is made whether the student successfully or unsuccessfully accomplished the event. If the event was unsuccessfully accomplished, an insurance claim can be filed and, if determined to be valid, a claim benefit is issued to the insured allowing the student to retake the insured event in the future without again paying the full enrollment fee for the insured event.

### BACKGROUND

The present invention relates, in general, to insurance and, more specifically, to educational insurance.

In post-secondary education, a student pays tuition for each course he or she takes, with the amount of course tuition, while varying from institution to institution, typically being based on the number of credits accorded the course or on a flat tuition rate based on a range of credit hours taken.

In a typical situation, the student satisfactorily completes all of the required course work and receives a passing grade. However, there is a possibility that the student may fail the course due to a number of factors, some within and some beyond his or her control, as well as intentionally withdrawing from the course before completion if not dropped before the drop/add period ends. The drop/add period is a period of time at the start of a semester during which a student may drop a course in which they previously enrolled and be charged nothing or only a fraction of the entire tuition cost to complete the course. In both cases in which the student fails or withdraws from a course after the drop/add period ends, the tuition paid by the student for that course is lost and the student will have to pay the full tuition cost to retake the course or an equivalent course in the future.

The financial risk of failing or withdrawing from an educational course is caused by many factors. First, the course may simply be more difficult than the student anticipated when he or she enrolled in it, and they just cannot grasp the course concept. The second factor is that the course requires a disproportionate amount of study time and therefore acts as a distraction from the rest of a student's course load. Third, the student may not have adjusted to their new independence and prioritize other activities above studying. Finally, a family or personal emergency, such as a death within the family or personal health issues, may disrupt the student's ability to focus on the work required to successfully complete the courses.

The options that a student has in response to these factors are to withdraw from the course(s) in which they are falling behind, accept a failing grade and allow it to adversely effect their grade point average, or divert time from other courses to focus on improving their performance in the course(s) they are struggling in because it is within their major, for example, which may incidentally cause a deterioration in their performances in the other courses. None of these options address the waste of financial resources that results when a student pays for a course, but fails or withdraws from it without completing the course and therefore does not receive credit for it.

The same factors apply to taking post-secondary school entry tests, such as the ACT and SAT, and post-graduate certification and entry tests, such as the GMAT, LSAT, GRE, MCAT, etc., as well as for part time students who receive reimbursement for tuition expenses as long as they earn above a predetermined grade in the course associated with the tuition expense.

Thus, would be desirable to provide a product to students which can decrease the financial hardship on the student due to unexpected circumstances, increase the confidence of the student by offering a second chance in overcoming obstacles, reduce the emotional pressure of failure that could create an incentive to cheat, increase the student's efficiency to balance education and life experiences, and increase motivation.

### SUMMARY

An educational insurance product and a process of implementing the same is disclosed.

A process for insuring a retaking of an insured event where the event has an enrollment cost, the ability to retake the insured event, and a definite successful or unsuccessful event accomplishment criteria.

The process includes steps of determining the variables that affect the total cost of benefit to the insured from a number of variables including at least one of a particular educational event withdrawal/failure rate, discounts for previous contract purchases, discounts for claim deductibles, cost per event credit hour, total event or course credits insured, and specific courses covered; determining the value of the variables; calculating a premium cost based on statistical concepts and the value of variables; paying the cost of the premium by an insured; enrollment of the insured in the insured event; at the end of the term of the insured event, if the insured meets the successful event accomplishment criteria, not paying any insurance premium, or if the insured does not meet the established criteria for successful event completion, issuing a claim benefit allowing the insured to retake the insured event without again paying the entire insured event enrollment fee.

An educational insurance product for use with an educational insured event which has an initial enrollment cost, successful accomplishment criteria, and the ability to retake the event by the insured upon unsuccessful accomplishment, includes an insurance policy issued to an insured for a particular insured event in exchange for payment of an insurance premium; a claim procedure in which a claim is submitted by the insured upon unsuccessful completion of the insured event; and issuance of a claim benefit to the insured to allow the insured to retake the insured event in the future if the claim is deemed valid.

This unique educational insurance product pays for a student to retake an insured event, such as a course or test in a subsequent enrollment period in consideration of payment of an insurance premium before the course or test begins.

The insurance product allows the student to make the best decision to withdraw from, fail, or complete the course regardless of the financial results for the student. If the student decides to withdraw from or fail the course in which the student is struggling, the student can take it again in the future without having to again pay for the entire enrollment cost of the course or test less any required deductibles. If the student decides to withdraw from or fail a different course to focus on the difficult course, then they can take the other course or test again without payment of the tuition for retaking the course less any required deductibles.

This education insurance also has the intangible benefit of addressing the emotional risk of failing or withdrawing from a course or test. When the student is paying for some or all of their tuition costs, the financial risk in their education causes added emotional pressure. This distraction reduces the student's focus on studying and can actually increase the chance that the student performs poorly in their enrolled courses. Protecting the financial investment proactively relieves the associated emotional pressure and increases confidence.

For parents who pay for some or all of their children's tuition costs, the parents expect a return on their investment in the student's education in the form of good grades. By eliminating the financial risk, parents will place more emphasis on their son or daughter learning the course material so that the student focuses on discovering their passion rather than merely passing the courses at all cost. The student will recognize this action as supportive and be more inclined to perform well.

Whether or not the unique educational insurance eliminates all of the student's or the parents' financial risk, it will reduce the student's incentive to respond to this pressure with shortcuts, such as cheating, cramming, etc. Such shortcuts aim at short term results to acquire good grades at the expense of the long term goal of post-term education which is to discover one's passion and acquire skills that will enable them to excel in a career.

The present insurance product also provides benefits to the education institution by generating additional revenues with minimal incremental implementation expense, increases the probability of retaining students at the institution and thereby reduces drop-out rate, poses no financial risk to the institution, and enhances the student's perception of the university's support in them.

### BRIEF DESCRIPTION OF THE DRAWING

The various features, advantages, and other uses of the present invention will become more apparent by referring to the following detailed description and drawing in which:

FIG. 1 is a flow chart depicting a process for determining the cost of an insured event insurance premium;

FIG. 2 is a flow diagram depicting the process for processing insurance claims;

FIG. 3 is a screen display of information fields entered by the student, the educational institution and insurance premium calculation results;

FIGS. 4A and 4B are charts showing insurance premium calculations based on the withdrawal and/or failure probabilities for one or more insured events; and

FIGS. 5A and 5B are sample statistical calculation for the premium of an insurance policy that insures five events.

### DETAILED DESCRIPTION

Before describing a unique education insurance product and process for implementing the same, it will be understood that although the following description makes extensive use of educational insurance for a post-secondary school course, such as post-high school, college or university courses, it will be understood that the term “course” can be any course at any secondary or post secondary school institution where a tuition payment or enrollment fee is paid for a particular course or test. The term “course” will also be understood to cover tests, such as post-secondary school entry tests, such as ACT and SAT, post-graduate entry tests, such as the GMAT, LSAT, GRE, MCAT, etc., and professional certification exams, such as CPA, etc. The term “course” also connotes an education event, such as an educational course or test, which has the ability for retaking of the course or test.

By example only, the unique education insurance product will be described in conjunction with a single semester post-secondary school or university course load of five courses in which a student pays “X” dollars per credit hour assigned to each course or “X” dollars for an entire semester. The courses can be in any educational discipline, be a required course for the student's major, an elective course, a basic course required for all students, etc.

It will be understood, however, that the unique education insurance product described hereafter can be used with any number of courses in a given semester, from as low as one to more than five. The present educational insurance product may provide the student with the option to insure one course, two courses, or an entire semester and allows the student to customize the protection to optimize its cost-benefit. For example, if the student thinks that only one course will distract him or her from the other courses that the student is taking, the student can insure just that one course and focus on the other courses that matter most. If all the classes are of interest to a student and the student wishes to focus on each one equally, but doesn't know which one will be the hardest for the student, then the student can insure the entire semester with a blanket policy.

Also, the student can choose how much the student would like to pay up front versus the size of the optional deductible the student would be responsible for later in the event of a withdrawal or failure.

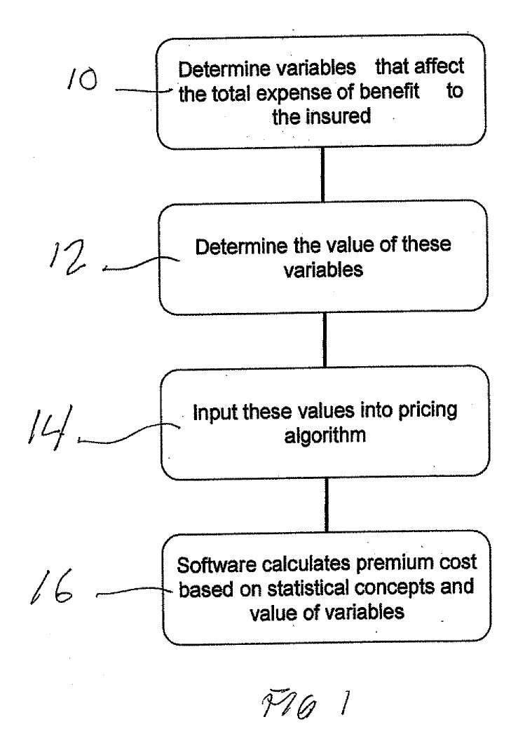

First, as shown in FIG. 1, an insurance premium is calculated which can be paid by the student prior to or at the time of enrolling in the course or test and which will allow the student to retake the course within a set period of time, such as within one to two years, for example, if the student withdraws from the course during the semester after a defined drop/add period expires, or fails the course without withdrawing prior to the end of the semester.

The first step 10 shown in FIG. 1 involves a determination of the variables that affect the total expense of benefit to the insured. Examples of such variables include withdrawal and/or failure rates of a specific course or an entire subject, such as math, science, etc., discounts for previous contract purchases, cost per course credit hour, total credits insured, courses covered, etc.

It will be understood that a particular institution can provide the education insurance on only some courses, for some majors, for only courses having a minimum number of credits, etc. Universities or post-secondary institutions know that statistically speaking, a higher percentage of students will withdraw from or fail certain types of classes. For example, mathematics classes generally have a much higher withdrawal/failure rate than do English, political science, statistics or sociology classes.

By way of example only, the variables used in determining the insurance premium for a particular course, full semester course load, etc., as well as the amount of the premium and the amount of payout or benefit for a valid claim are determined by variables that include, but are not limited to one or more of: the size of the educational institution, whether the education institution is public or private, cost per course credit hour, whether the course runs for a semester or a full term, the level of the student in the educational program, whether the student is a resident or non-resident, the nature or subject matter of the courses themselves, total tuition costs, the insurance policy deductible, and any adjustments to the underlying insurance assumptions.

One variable of post-secondary education is the distinction between public universities and private universities or private colleges. Generally speaking, public universities have looser standards of acceptance compared to private institutions. This variation in acceptance requirements correlates to the difference in withdrawal and failure rates between public and private institutions. Data suggests that public institutions may have 50% to 100% higher withdrawal and/or failure rates than a similar sized private educational institution.

The size of the student body at the educational institution will often determine the level of competition when comparing different institutions. The greater number of students attending an institution creates higher competition which is often managed by grading on a curve. The curve dictates that each category of the grade distribution is limited to include only a certain percentage of students. This system contrasts to the absolute quantitative scores where a student earns a predetermined grade dependent only on the overall score the student achieves. In the case of the curve, the failure and withdrawal categories are often used as buckets of last resort to include less competitive students determined by test scores that are relatively too low to be classified in any other category.

This higher competition increases the chance of a student receiving a failing grade or choosing to withdraw from a course. Smaller schools have less competition and often no grading curve. Hypothetically, each student at such a small institution could earn an “A” under the absolute quantitative grading system.

With respect to tuition costs, the higher the tuition costs per semester will cause the cost of the present education insurance policy to increase. The more expensive policy insures a higher relative risk.

For schools with the lowest tuition per semester, while lower tuition per semester cost decreases the financial risk of enrollment and therefore decreases the cost of an insurance policy, the internal fixed cost of underwriting and marketing the educational product will create a cost floor that causes the price or premium of the insurance policy to remain higher than the tuition costs per semester would normally justify.

The class or grade level of the student will determine the interest and need they have for the educational product. First year and returning freshman, as well as sophomores, might have the greatest interest in this insurance product. This group has more uncertainty regarding their skills and chosen majors or courses. Therefore, they have the greatest probability of attempting courses outside their specialty or skill level in order to discover their passion thereby increasing the chance for withdrawal or failure.

Also, living away from home is a new experience for many students. Extra curricular interests may serve as a distraction from studying. Generally speaking, higher level students, such as juniors and seniors, may have a lower need for the educational product since such students have lived on their own and away from their parents for some time.

A student's interest in the educational product is partially determined by the group of courses in which the student is enrolled and/or the major that they have chosen. Each educational department in any institution has its unique withdrawal and/or failure rates resulting in the combination of the difficulty of its subjects and the makeup of the enrolled student body. Generally speaking, a mathematics course has a higher failure and withdrawal rate than an English course which in turn has a higher failure and withdrawal rate than a music course. Therefore, students enrolled in mathematics that are not majoring in mathematics would have a greater need to protect their investment in a given semester. On the other hand, students majoring in mathematics would be enrolled in the same courses as students enrolled in mathematics to simply fulfill a math requirement. The former must achieve a passing grade for it to count toward their major and will therefore focus more effort on their mathematic courses relative to their other courses that semester. The latter will be more likely to fail or withdraw as marginal students due to focusing more on other courses in which they are more interested.

The total expense of benefit can be defined as the direct costs of offering the insurance, such as potential claims paid for retaking of a particular course, as well as indirect costs, such as insurance marketing, claim processing, etc.

The next step is to determine the value of these variables in step 12 and then to input these values in step 14 into a pricing algorithm. Such pricing algorithms are common in the insurance industry and generally employ a software program, as shown in step 16, which calculates the premium cost based on statistical concepts and the value of the variables.

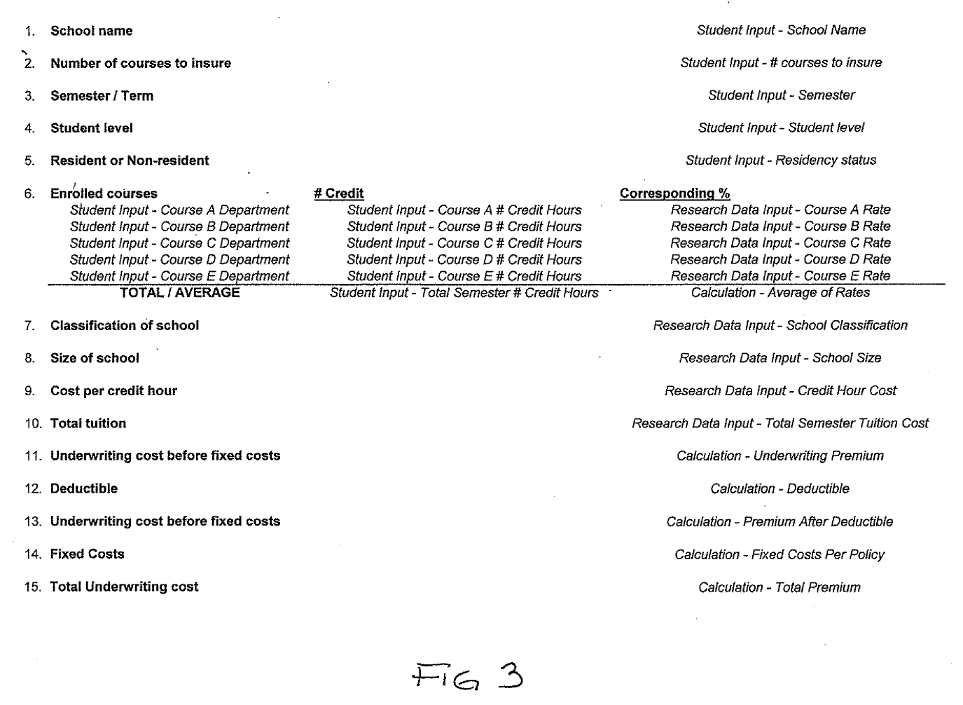

Referring now to FIG. 3, there is depicted a computer generated screen display which a student may use to input certain course information, the educational institution may use to input values from withdrawal/failure rates for that particular institution, and certain calculations are automatically performed to generate an insurance premium for the selected number and types of courses taking into account some or all of the variables described above. By way of example only, an example student is enrolling in five courses for the upcoming semester, labeled courses ABCDE, as shown in FIG. 3.

The values inputted by the educational institution come from that particular institution's data of withdrawal and/or failure rates and grade distribution.

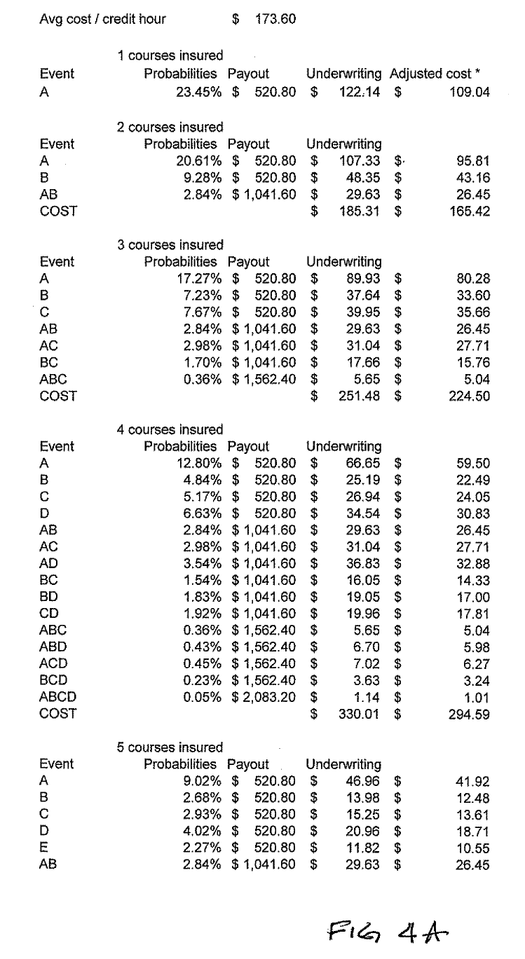

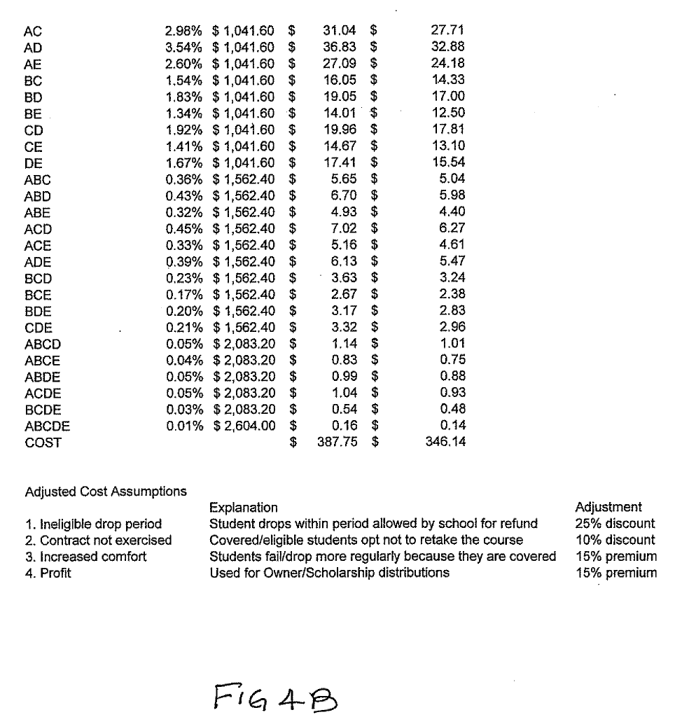

The numbers shown for credit hour costs, total tuition costs and underwriting costs are given by way of example only. It will also be understood that the same premium calculation process, as described hereafter, will be employed for enrollment in a single class, two classes, etc. This is illustrated in FIGS. 4A and 4B which depict probabilities, pay out, underwriting cost and adjusted cost for insuring one event, two events, three events, four events or five events.

As is readily apparent the greater the number of insured events, such as courses or tests, that are insured at one time, the lower the probability of the student failing or withdrawing from all of the insured events. The different probabilities which are dependent upon course type, such as Event A which corresponds to a mathematics course and Event B, which corresponds to an English course, are shown in the various insured event groups depicted in FIGS. 4A and 4B.

Also apparent from FIGS. 4A and 4B is that while the total insured costs increases in proportion to the courses or events which are insured, the premium per course decreases due to the lower total probability and therefore risks that a student will withdraw and/or fail all of the insured events.

The last column to the right in FIGS. 4A and 4B depicts an adjusted cost which is based on several assumptions which may or may not be used in calculating the final premium cost. Such assumptions can include a 25% discount if the student drops a course within the period allowed by the school for refund of the course tuition. A 10% discount premium adjustment may be issued if a covered or eligible student opts not to retake the course which was insured. A 15% increase in the premium may be added if a particular student fails or drops more courses than normal because such courses are insured. Finally, 15% of the premium is provided for profit, by way of example only.

The probabilities of withdrawal and/or failure of one or more insured events shown in FIGS. 4A and 48 are examples of combined withdrawal and failure rates for one educational institution. It will be understood that the present educational insurance product can be used with separate withdrawal only rates, or with separate failure only rates and insurance premiums and insurance products offered separately for withdrawal only or failure only of an insured event(s). Also, it will be understood that the education insurance product can be customized to offer a base policy that covers a scenario in which the student withdraws from an entire semester of courses due to health issues.

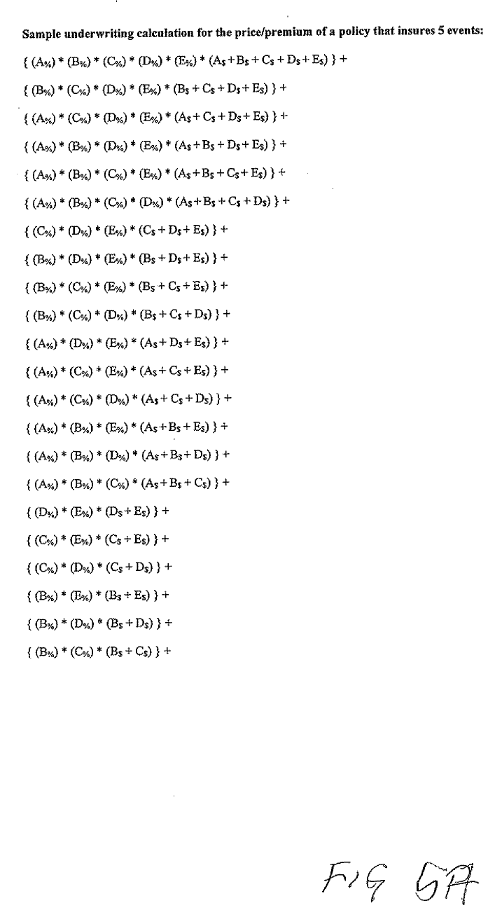

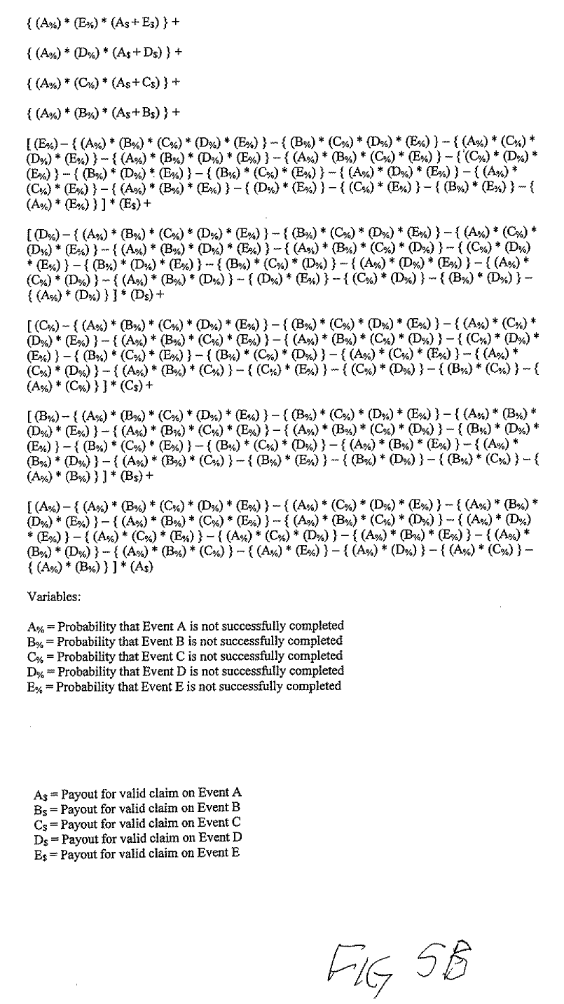

FIGS. 5A and 58 depict, by way of example only, the pricing algorithm which employs the probabilities shown in FIGS. 4A and 4B for five insured courses. A similar algorithm will be employed for a fewer number of courses insured during a particular semester resulting in the probabilities as shown in FIGS. 4A and 4B.

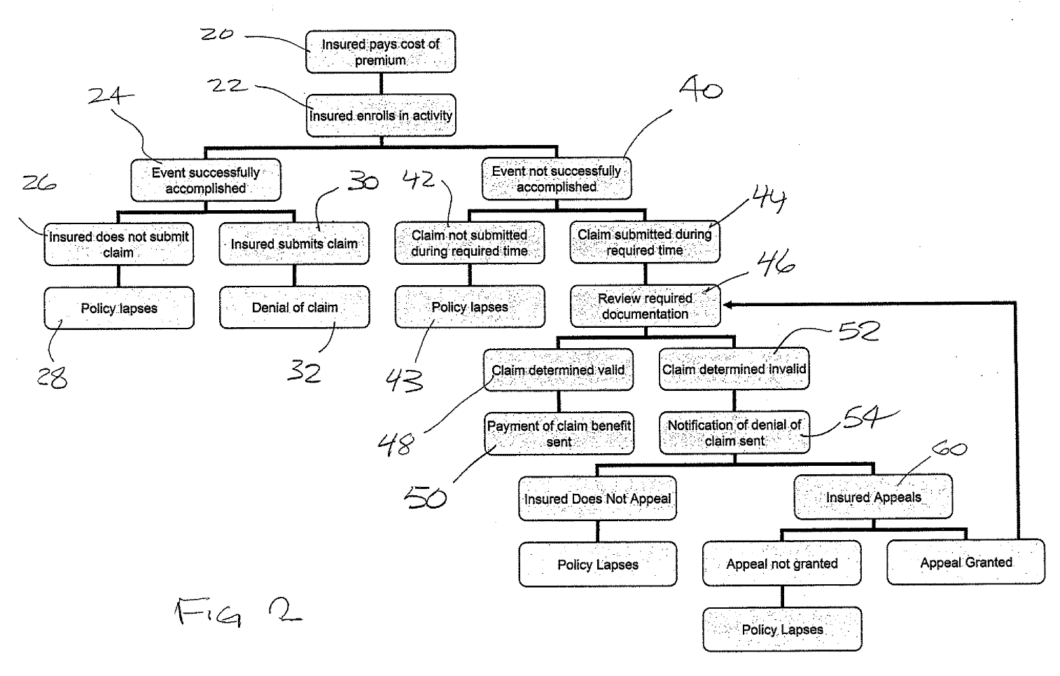

Once the premium is determined for each course which a particular institution offers, the student will be advised of the premium cost at the time of enrollment. The education insurance product premium will be paid at a preset time, such as at the time of the full payment of the course tuition or any other time set by the education institution and/or the insured such as when the premium payment is paid before the insured event access. Institutions may provide for a delayed payment, such as one week, etc., after the start of classes if it desires. This process is shown in steps 20 and 22 in FIG. 2.

A slightly different process may be employed for standardized tests that students must take in order to apply to undergraduate and graduate school and for professional certification exams. The student's actual test score is used as a factor by the post-secondary school's decision to accept the student or for the governing body to grant the professional certificate. Therefore there is substantial pressure on the student to score as high as possible on the standardized test and therefore the desire to retake it is equally as great if their goal for a particular high score is not achieved on a previous attempt. There are also limitations in the form of additional expense and the fact that some schools prefer to see that a student takes such tests only a limited number of times.

Pricing of the insurance premium for this type of education insurance may be based on a formula that accounts for the cost of the test times the probabilities that the student did not achieve a particular score times the probability that the student will retake the test. For example, if the student hopes to achieve a score of 600 or better on their first attempt on the GMAT test, the cost of the test is $250 and the score of 600 is in the 85th percentile and the probability that students retake the exam on the first attempt is 35%, the cost of underwriting this premium could be calculated as follows:

$250.00×0.85×0.35=$74.38 plus administrative costs less any deductible.

In situations where an employee is reimbursed by his or her employer for taking courses on a full or part time basis, such reimbursement is typically offered on the basis that the student achieves a particular grade in order to be eligible for reimbursement from their employer. Typically, companies today have implemented education assistance programs which require students to pay for all of the tuition costs prior to the completion of the semester. The employer will then reimburse the student for a percentage, typically 80%, for example, of the total tuition cost as long as the student achieves higher than a specific grade, such as a C. Many part-time students cannot afford to pay for the course themselves and have to rely on the employer's reimbursement. Receiving a grade lower than the minimum eligible for reimbursement could prevent the student from taking additional courses in future semesters.

Premium pricings for this type of education insurance for part time students will have a formula similar to that described above for full time students and will be based on the percentage of part time students who do not achieve a specified grade or better.

In step 24 of FIG. 2, the insured event such as particular course or test, is successfully completed. If the insured student does not submit a claim in step 26, whether intentionally or due to the fact that the student successfully accomplished the insured event, the insurance policy for that student for that particular course or insured event lapses in step 28.

If the event is successfully accomplished in step 24 and the insured still submits a claim in step 30, the claim will be denied in step 32 since the student has successfully accomplished the insured event.

If the insured event is not successfully accomplished by the student in step 40 in FIG. 2, the student will have a set time period to submit a claim. This period of time may be a variable time period which may end at the start of the next semester in which the unsuccessfully accomplished insured event is reoffered for the first time, or a pre-set chronological time period, such as one month, two months, etc.

If the insured does not submit a claim within the required time in step 42, the event insurance policy lapses in step 43. If a claim is submitted during the required time period in step 44, the education institution, the insurer or a third party organization will review documentation submitted with the claim in step 46 to make a valid or invalid claim determination. If the claim is determined valid in step 48, an indication of the claimed benefit will be sent to the student in step 50. This indication of claimed benefit can be a credit issued to the student to retake the class at the institution within the set time period without paying additional tuition for that course or test.

Alternately, if the claim is determined invalid in step 52, notification of denial of the claim will be sent to the institution and the insured in step 54.

After notification of denial of a claim is sent in step 54, the insured has an optional appeal and reconsideration process as also shown in FIG. 2. If the insured does not appeal in step 56, then the insurance policy lapses in step 58.

If the insured files an appeal in step 60, the institution, or governing body, and the insurer have the option to reject the appeal in step 62, after which the insurance policy lapses in step 64.

If the student's appeal in step 60 is accepted in step 68, the reviewer in step 46 again reviews the claim information along with any additional information the student or institution may provide and can make a new determination if the claim is valid as in step 48 or the claim remains invalid in step 52. It will also be understood that the present education insurance can provide for a deductible or only a percentage of full enrollment cost of the insured event for retaking the insured event.

The deductible or the amount of the deductible is optional in the educational insurance product. If a deductible is employed, it can be calculated as a percentage of the total insured events for one student in one semester, such as the cost of the five courses taken by the student in the example. This deductible, which can be between 1% to 20%, or more, of the total insured cost, is the amount the student will have to pay to retake the insured event.

The present product and process also contemplates offering the student a variety of different deductible amounts with a corresponding different premium so that the student may make a choice based on his or her educational situation.

In addition, the product and process can be modified to enable an issued claim benefit under an insurance policy to be used by a student to enroll in a different course but, in the same or different department, i.e., mathematics, English, etc., than the one previously covered by the insurance policy.

It is also possible to expand the usage of the described insurance product by offering incentive programs. For example, a discount, such as a 5% discount on the premium, can be offered to students who purchase the education insurance via computer over the Internet. This could be an ongoing or temporary incentive. Another incentive is the offering of a discounted premium rate to purchase additional semesters at one time or to insure the entire college career of a student. The premiums in such case would typically be based on the student's current course load since the student has not yet registered for future courses. A premium discount could also be offered for students not making a claim in a previous semester.

What is claimed is:

1. A process for allowing a reduced cost retaking of an insured education event where the insured event has an enrollment cost, the ability to retake the insured event, and a definite successful or unsuccessful event accomplishment criteria, the process comprising the steps of:
determining values of variables that affect the total cost of benefit to the insured;
calculating a premium cost based on statistical concepts and the value of the variables;
paying the cost of the premium by an insured;
enrolling of the insured in the insured event;
ending of the insured event;
if the insured meets the successful event accomplishment criteria, not paying any benefit to the insured; and
if the insured does not meet the successful event accomplishment criteria, issuing a claim benefit allowing the insured to retake the insured event without again paying the total insured event enrollment fee.

2. The process of claim 1 wherein the step of issuing the claim benefit allows the insured to retake the insured event within a predefined period of time.

3. The process of claim 1 further comprising the step of:
requiring an insurance claim be submitted by the insured with a predefined time period after the end of the insured event.

4. The process of claim 1 further comprising the step of:
providing a deductible in the claimed benefit to the insured based at least in part on calculating a premium taking into account the insured event cost.

5. The process of claim 4 wherein the step of providing a deductible further comprises the step of:
providing the deductible of a percentage of the enrollment cost of the insured event.

6. The process of claim 1 further comprising:
covering at least one of an educational course and an educational test as the insured event.

7. The process of claim 1 wherein the variables includes the step of determining the value of at least one of:
determining the size of the educational institution;
determining whether the education institution is public or private;
determining the cost per credit hour of insured event;
determining whether the course runs for a semester or term;
determining the level of the student in the educational program;
determining whether the student is a resident or non-resident;
determining the nature of the insured event;
determining total enrollment costs;
determining the insurance policy deductible; and
making any adjustments to the underlying assumptions.

8. The process of claim 1 further including the step of:
establishing a non-successful event accomplishment criteria including at least one of withdrawal from the insured event before the end of the insured event and failure to achieve the successful event accomplished criteria after the end of the insured event and completion of the insured event by the insured.

9. An education insurance product for use with an education insured event which has an initial enrollment cost, successful event accomplishment criteria, and the ability to retake the event by the insured upon unsuccessful accomplishment comprising:
an insurance policy issued to an insured for a particular insured event in exchange for payment of an insurance premium;
a claim procedure in which a claim is submitted by the insured after the end of the insured event; and
a claim benefit issued to the insured to allow the insured to retake the insured event without again paying the entire enrollment fee for the insured event upon meeting claim benefit standards.

10. The insurance product of claim 9 further comprising:
a deductible in the claim benefit to the insured based at least in part on calculating a premium taking into account the cost of the insured event.

11. The insurance product of claim 10 wherein:
the deductible is a percentage of the enrollment cost of the insured event.

12. The insurance product of claim 9 wherein:
the insured event is at least one of an educational course or an educational test.

13. The insurance product of claim 9 wherein the variables include at least one of:
the size of the educational institution;
whether the education institution is public or private, the cost of the insured event per credit hour;
whether the insured event runs for a semester or term;
the level of the student in the educational program;
whether the student is a resident or non-resident;
the nature of the insured event itself;
insured event total costs;
the insurance policy deductible; and
adjustments to the underlying assumptions.

14. The insurance product of claim 9 wherein:
a determination of a non-successful event accomplishment criteria includes at least one of withdrawal from the insured event before the end of the insured event and failure to achieve the successful event accomplished criteria after the end of the insured event and completion of the insured event by the insured.
